(19) United States
(12) Patent Application Publication
(10) Pub. No.: US 2020/0198432 A1
(43) Pub. Date: Jun. 25, 2020

(54) SUSPENSION SYSTEM WITH ADJUSTABLE RIDE HEIGHT

(71) Applicant: SCHAEFFLER TECHNOLOGIES AG & CO. KG, HERZOGENAURACH (DE)

(72) Inventor: Shaun TATE, Grand Blanc, MI (US)

(73) Assignee: SCHAEFFLER TECHNOLOGIES AG & CO. KG, HERZOGENAURACH (DE)

(21) Appl. No.: 16/225,716

(22) Filed: Dec. 19, 2018

(51) Int. Cl. B60G 17/027; B60G 17/015; B60G 17/052

(52) U.S. Cl. CPC B60G 17/0275; B60G 11/465; B60G 17/0525; B60G 17/0155

(57) ABSTRACT

A suspension system for use between a frame and a beam axle includes a ride-height adjustment mechanism connectable between the frame and the beam axle. The adjustment mechanism includes an upper spring seat configured to mount to the frame and a lower spring seat configured to mount to the beam axle. A spring is interposed between the upper and lower spring seats. An electromechanical actuator arrangement is configured to move the upper spring seat relative to the frame or the lower spring seat relative to the beam axle so that a distance between the frame and the beam axle can be increased or decreased.

### TECHNICAL FIELD

The present disclosure relates to suspension systems for use with beam axles, and more specifically to suspension systems that include a leaf-spring arrangement and a ride-height adjustment mechanism in parallel.

### BACKGROUND

Vehicles include suspension systems connected between the wheels and the chassis. Suspension systems include springs, dampers, e.g., shock absorbers, linkages, etcetera that connect the wheels to the chassis in way that permits relative motion between the wheels and the chassis. The suspension system absorbs road disturbances to improve both vehicle dynamics and ride comfort.

Some suspension systems are active and allow the ride height to be increased or decreased on command. Air suspension systems are one example of an active suspension systems. Air suspension systems include pneumatic springs, e.g., flexible bellows, that are filled with air by an air compressor. The ride height may be increased or decreased by adding or removing air from the bellows.

### SUMMARY

According to one embodiment, a suspension system for use between a frame and a beam axle includes a ride-height adjustment mechanism connectable between the frame and the beam axle. The adjustment mechanism includes an upper spring seat configured to mount to the frame and a lower spring seat configured to mount to the beam axle. A coil spring is interposed between the upper and lower spring seats. An electromechanical actuator arrangement is configured to move the upper spring seat relative to the frame or the lower spring seat relative to the beam axle so that a distance between the frame and the beam axle can be increased or decreased. A leaf spring may be connected between the frame and the beam axle in parallel with the ride-height adjustment mechanism. The ride-height adjustment mechanism is configured to adjust ride height of the vehicle without modifying a spring rate of the coil spring. The actuator arrangement may include a linear actuator driven by an electric motor. In some embodiments, the adjustment mechanism further includes a body attachable to the beam axle and supporting the lower spring seat. The actuator arrangement is configured to axially move the lower spring seat relative to the body to adjust ride height. In other embodiments, the adjustment mechanism further includes a body attachable to the frame and supporting the upper spring seat. The actuator arrangement is configured to axially move the upper spring seat relative to the body.

According to another embodiment, a suspension system includes a frame, an axle, and a ride-height adjustment mechanism configured to move the frame relative to the axle. The adjustment mechanism includes a body fixed to one of the frame and the axle, a first spring seat fixed to the other of the frame and the axle, a second spring seat movably attached to the body, and a spring interposed between the first and second spring seats. An actuator arrangement is configured to axially move the second spring seat relative to the body. The ride-height adjustment mechanism is configured to adjust ride height of the vehicle without modifying a spring rate of the spring. The actuator arrangement may be electromechanical such as an electric motor. The suspension system may include a leaf spring connected between the frame and the axle and may include a damper, e.g., shock absorber, between the frame and the axle.

According to yet another embodiment, a suspension system for use with a beam axle includes a leaf spring connectable between a frame and a beam axle. An electromechanical ride-height adjustment mechanism is interposable between the frame and the beam axle and includes upper and lower spring seats and a spring interposed between the spring seats. An actuator arrangement, which may include an electric motor, is configured to move the upper and lower spring seats relative to each other to adjust a distance between the frame and the beam axle. The ride-height adjustment mechanism may be configured to adjust the ride height of the vehicle without modifying a spring rate of the spring. In some embodiments, the lower spring seat is attachable to the beam axle, and the ride-height adjustment mechanism further includes a body attachable to the frame. The upper spring seat is movably connected to the body, and the actuator arrangement is further configured to axially move the upper spring seat relative to the body to adjust a position of the upper spring seat relative to the frame. In other embodiments, the upper spring seat is attachable to the frame, and the ride-height adjustment mechanism further includes a body attachable to the beam axle. The lower spring seat is movably connected to the body, and the actuator arrangement is further configured to axially move the lower spring seat relative to the body to adjust a position of the lower spring seat relative to the beam axle.

### BRIEF DESCRIPTION OF THE DRAWINGS

FIG. 1 is a schematic perspective view of a vehicle.

FIG. 2 is a perspective view of a suspension system of the vehicle.

FIG. 3 is a cross-sectional view of a ride-height adjustment mechanism of the suspension system.

FIG. 4 is a schematic diagram illustrating actuation of the suspension system to adjust ride height of the vehicle.

FIG. 5 is a cross-sectional view of another ride-height adjustment mechanism of the suspension system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

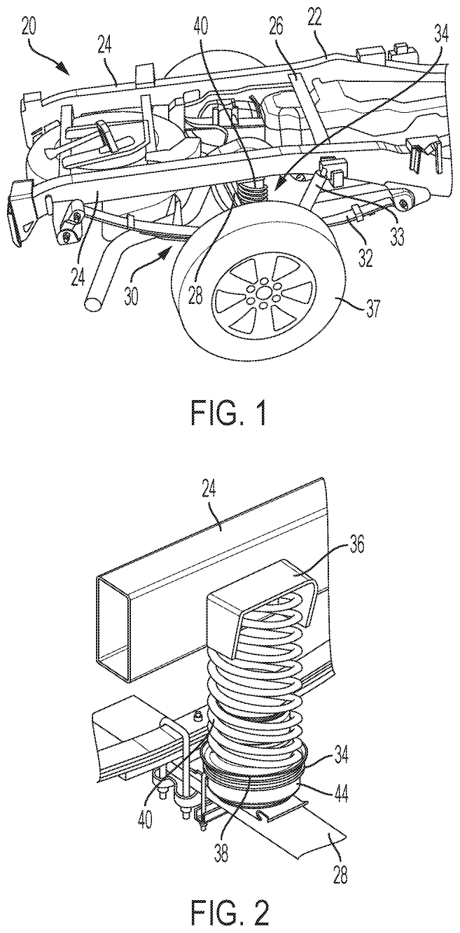

Referring to FIG. 1, a vehicle 20, such as a truck, includes a frame 22 having a pair of spaced longitudinal frame rails 24 and cross members 26 attached between the frame rails 24. The vehicle 20 may include one or more beam axles 28 that are connected to the frame 22 via a suspension system 30. The beam axle 28 connects between the rear wheels 37. Thus, the vehicle 20 includes a solid rear axle and the rear suspension system 30 is a dependent suspension system. The suspension system 30 may include leaf springs 32, dampers 33, e.g., shock absorbers, and ride-height adjustment mechanisms 34. For example, each wheel 37 may include an associated leaf spring, a shock absorber, and a ride-height adjustment mechanism. The ride-height adjustment mechanisms 34 are configured to raise and lower the frame 22 (and the body attached thereto) relative to the ground. The ride-height adjustment mechanisms 34 may include springs 40 that contribute to the total spring rate for the suspension system 30.

FIG. 1 shows the rear suspension of the vehicle 20, and the front suspension may include the suspension 30 or a different type of suspension. For example, the front suspension may be independent suspension or may be dependent suspension but employ a different design, e.g., coil springs.

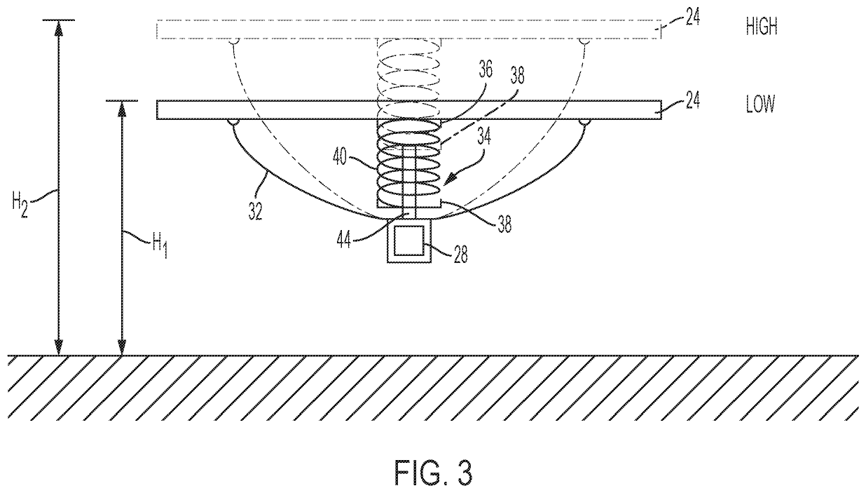

Referring to FIGS. 2 and 3, the ride-height adjustment mechanism 34 is configured to raise and lower the ride height of the vehicle. The ride-height adjustment mechanism 34 may include an upper spring seat 36, a lower spring seat 38, and the coil spring 40 disposed therebetween. In the illustrated embodiment, the upper spring seat 36 is fixed to one of the frame rails 24 and the lower spring seat 38 is movably attached to a base 44 of the adjustment mechanism 34. The base 44 is fixed to the beam axle 28. The upper end of the coil spring 40 is attached to the upper spring seat 36 and a lower end of the coil spring 40 is attached to the lower spring seat 38. The lower spring seat 38 is movable up-and-down to raise and lower ride height of the vehicle between a minimum height H₁, a maximum height H2, and intermediate positions therebetween. The ride-height adjustment mechanism 34 may be used to vary vehicle ride height for vehicle dynamics and/or may be used for load leveling the vehicle 20.

The ride-height adjustment mechanisms 34 change the ride height of the vehicle by adjusting the location of the coil spring 40 relative to the ground or frame 22 as opposed to increasing or decreasing a spring rate. That is, the spring rate of the suspension system 30 is not changed as the ride height is adjusted. This is in contrast to air suspension in which the spring rate changes response to inflation and deflations of the air bellows.

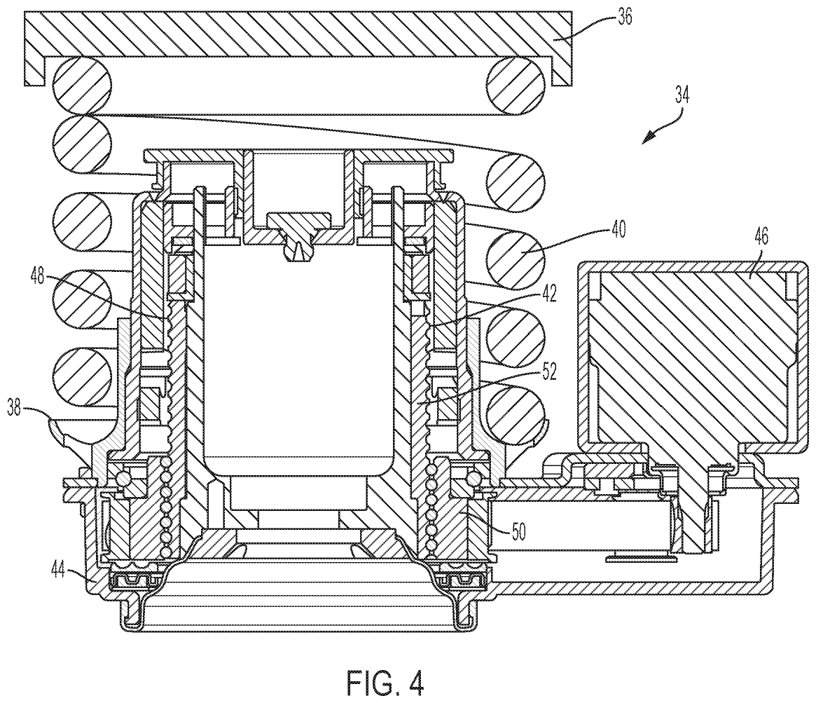

Referring to FIG. 4, the ride-height adjustment mechanism 34, according to one embodiment, includes an actuator arrangement 42 configured to adjust the position of the lower spring seat 38 relative to the base 44. The actuator arrangement 42 may be electromechanical and includes an electric motor 46 that drives a linear actuator 48. In the illustrated embodiment, the linear actuator 48 is a ball screw mechanism that includes a ball nut 50 and a screw shaft 52. The nut 50 is operably coupled to the electric actuator 46, which rotates the ball nut 50 on the screw shaft 52 to raise and lower the spring seat 38 relative to the base 44. The ball screw mechanism may include a spline lock or a wave lock that retains the nut 50 at an axial position of the screw shaft 52 when the electric actuator 46 is de-energized.

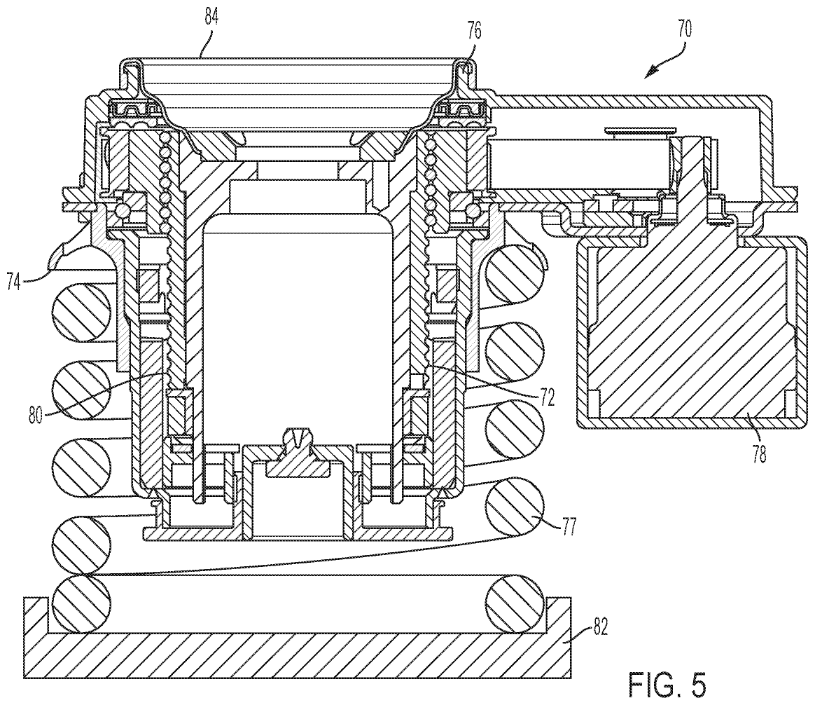

Referring to FIG. 5, in an alternative embodiment, the ride-height adjustment mechanism of FIG. 4 may be rotated by 180 degrees so that the lower spring seat is fixed to the beam axle 28 and the upper spring seat is movably attached to frame 24 to adjust the ride height of the vehicle. For example, a ride-height adjustment mechanism 70 includes an actuator arrangement 72 configured to adjust the position of an upper spring seat 74 relative to a base 76. A coil spring 77 acts between the upper spring seat 74 and a lower spring seat 82. The lower spring seat 82 may be fixed to the beam axle. The actuator arrangement may be electromechanical and includes an electric motor 78 that drives a linear actuator 80. The linear actuator 80 may a ball screw mechanism as described above. By adjusting the position of the upper seat 74, the distance between the top of the spring 77 and the top 84 of the adjustment mechanism 70, which is fixed to the vehicle chassis, is increased or decreased to raise and lower the vehicle relative to the ground. That is, moving the upper seat 74 away from the base 76 increases ride height and moving the upper seat 74 towards the base 76 decreases ride height.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

20 vehicle
22 frame
24 longitudinal frame rails
26 crossmembers
28 beam axle
30 suspension system
32 leaf spring
34 ride-height adjustment mechanism
36 upper spring seat
38 lower spring seat
40 coil spring
42 actuator arrangement
44 base
46 electric actuator
48 linear actuator
50 ball nut
70 ride-height adjustment mechanism
72 actuator arrangement
74 upper spring seat
76 base
77 spring
78 electric motor
80 linear actuator
82 lower spring seat
84 top

What is claimed is:

1. A suspension system for use between a frame and a beam axle comprising:
a ride-height adjustment mechanism connectable between the frame and the beam axle, the adjustment mechanism including:
an upper spring seat configured to mount to the frame,
a lower spring seat configured to mount to the beam axle,
a spring interposed between the upper and lower spring seats, and
an electromechanical actuator arrangement configured to move (i) the upper spring seat relative to the frame or (ii) the lower spring seat relative to the beam axle so that a distance between the frame and the beam axle can be increased or decreased.

2. The suspension system of claim 1 further comprising a leaf spring connected between the frame and the beam axle.

3. The suspension system of claim 1, wherein the actuator arrangement is configured to move the upper spring seat relative to the frame.

4. The suspension system of claim 3, wherein the adjustment mechanism further includes a body attachable to the frame and supporting the upper spring seat, wherein the actuator arrangement is configured to axially move the upper spring seat relative to the body.

5. The suspension system of claim 4, wherein the actuator arrangement includes a linear actuator driven by an electric motor.

6. The suspension system of claim 1, wherein the actuator arrangement is configured to move the lower spring seat relative to the beam axle.

7. The suspension system of claim 6, wherein the adjustment mechanism further includes a body attachable to the beam axle and supporting the lower spring seat, wherein the actuator arrangement is configured to axially move the lower spring seat relative to the body.

8. The suspension system of claim 7, wherein the actuator arrangement includes a linear actuator driven by an electric motor.

9. The suspension system of claim 1, wherein the actuator arrangement includes an electric motor.

10. The suspension system of claim 1, wherein a spring rate of the spring is unaffected by activation of the actuator arrangement.

11. A suspension system comprising:
a frame;
an axle; and
a ride-height adjustment mechanism configured to move the frame relative to the axle, the adjustment mechanism including:
a body fixed to one of the frame and the axle,
a first spring seat fixed to the other of the frame and the axle,
a second spring seat movably attached to the body,
a spring interposed between the first and second spring seats, and
an actuator arrangement configured to axially move the second spring seat relative to the body.

12. The suspension system of claim 11, wherein the body is fixed to the frame and the first spring seat is fixed to the axle.

13. The suspension system of claim 11, wherein the body is fixed to the axle and the first spring seat is fixed to the frame.

14. The suspension system of claim 11 further comprising a leaf spring connected between the frame and the axle.

15. The suspension system of claim 11, wherein the actuator arrangement includes a linear actuator.

16. The suspension system of claim 15, wherein the linear actuator is a ball screw.

17. The suspension system of claim 11 further comprising a damper connectable between the beam axle and the frame.

18. A suspension system for use with a beam axle comprising:
a leaf spring connectable between a frame and a beam axle; and
an electromechanical ride-height adjustment mechanism interposable between the frame and the beam axle, the ride-height adjustment mechanism including upper and lower spring seats, a spring interposed between the spring seats, and an actuator arrangement configured to move the upper and lower spring seats relative to each other to adjust a distance between the frame and the beam axle.

19. The suspension system of claim 18, wherein the lower spring seat is attachable to the beam axle, and the ride-height adjustment mechanism further includes a body attachable to the frame, wherein the upper spring seat is movably connected to the body, and the actuator arrangement is further configured to axially move the upper spring seat relative to the body to adjust a position of the upper spring seat relative to the frame.

20. The suspension system of claim 18, wherein the upper spring seat is attachable to the frame, and the ride-height adjustment mechanism further includes a body attachable to the beam axle, wherein the lower spring seat is movably connected to the body, and the actuator arrangement is further configured to axially move the lower spring seat relative to the body to adjust a position of the lower spring seat relative to the beam axle.
